(19) United States
(12) Patent Application Publication
(10) Pub. No.: US 2020/0047414 A1
(43) Pub. Date: Feb. 13, 2020

(54) FABRICATING A REPLACEMENT COMPONENT

(71) Applicant: Hewlett-Packard Development Company, L.P., Spring, TX (US)

(72) Inventors: Sunil Kothari, Palo Alto, CA (US); Wesley R. Schalk, Vancouver, WA (US); Francisco Jose Oblea Ramirez, Guadalajara (MX); Jun Zeng, Palo Alto, CA (US); Gary J. Dispoto, Palo Alto, CA (US)

(73) Assignee: Hewlett-Packard Development Company, L.P., Spring, TX (US)

(21) Appl. No.: 16/344,516

(22) PCT Filed: Jan. 17, 2017
(86) PCT No.: PCT/US2017/013700

§ 371 Date: Apr. 24, 2019

(51) Int. Cl. B29C 64/386; G05B 23/02; G06Q 10/00; B33Y 30/00; B33Y 50/00; B33Y 10/00

(52) U.S. Cl. CPC B29C 64/386; G05B 23/0283; B33Y 10/00; B33Y 30/00; B33Y 50/00; G06Q 10/20

(57) ABSTRACT

A system includes an interface to receive data from a number of sensors coupled to components of a device to monitor health of each of those components and a processor and memory to, in response to a determination that a first of the components is to be replaced, locate an additive manufacturing device that is capable of fabrication of a replacement component without interrupting fabrication cycles of that additive manufacturing device before the first component fails and to instruct fabrication of the replacement component.

### BACKGROUND

An additive manufacturing device is used to fabricate a three-dimensional (3D) object. The additive manufacturing device fabricates the 3D object by depositing layers of build material corresponding to slices of a computer-aided design (CAD) model that represents the 3D object. Some additive manufacturing machines are referred to as 3D printing devices because they use types of printing technology to deposit some of the manufacturing materials.

### BRIEF DESCRIPTION OF THE DRAWINGS

The accompanying drawings illustrate various examples of the principles described herein and are a part of the specification. The examples do not limit the scope of the claims.

FIG. 1 is a diagram of a system for fabricating a replacement component for a device, according to one example consistent with the disclosed implementations.

FIG. 2 is a diagram of a system for fabricating a replacement component for a device, according to one example consistent with the disclosed implementations.

FIG. 3 is a diagram of a system for fabricating a replacement component for an additive manufacturing device, according to one example consistent with the disclosed implementations.

FIG. 4 is a diagram of a system for fabricating a replacement component for an additive manufacturing device, according to one example consistent with the disclosed implementations.

FIG. 5 is a diagram of a fabrication schedule, according to one example consistent with the disclosed implementations.

FIG. 6A is a diagram of a sensor monitoring temperature, according to one example consistent with the disclosed implementations.

FIG. 6B is a diagram of a sensor monitoring humidity, according to one example consistent with the disclosed implementations.

FIG. 6C is a diagram monitoring life expectancy of a component, according to one example consistent with the disclosed implementations.

FIG. 7 is a flowchart of a method for fabricating a replacement component, according to one example consistent with the disclosed implementations.

FIG. 8 is a flowchart of a method for fabricating a replacement component, according to one example consistent with the disclosed implementations.

Throughout the drawings, identical reference numbers designate similar, but not necessarily identical, elements.

### DETAILED DESCRIPTION

As mentioned above, an additive manufacturing device fabricates a three-dimensional (3D) object from a computer-aided design (CAD) model representing the 3D object. Once the CAD model of the 3D object is created, the CAD model is processed into a number of slices. Each of the slices corresponds to a layer of the 3D object to be fabricated by the additive manufacturing device. The additive manufacturing device fabricates a portion of the 3D object by depositing a first layer of build material representing the first slice of the CAD model. The additive manufacturing device then fabricates subsequent portions of the 3D object by depositing subsequent layers of the build material representing subsequent slices of the CAD model on top of the first layer until the 3D object is fabricated.

Various types of additive manufacturing device include numerous components. The components include brackets, handles, a carriage, print heads, chambers to hold powders and agents, heating components, cooling components, covers, ducting, structural components, and other components. These components work together to fabricate the 3D object as well as perform other functions.

During the fabrication process of the 3D object, the components of the additive manufacturing device are subject to wear and tear. For example, as the powders are heated and cooled, the chambers that hold the powders expand and contract. This causes wear on these chambers. Over enough time, if the wear on a chamber is substantial, the chamber will eventually fail. As a result, the additive manufacturing device may be rendered non-functioning because one or more chambers can no longer hold the powders or other build material needed to fabricate 3D objects.

When the additive manufacturing device can no longer operate, a visual inspection may be conducted to determine which component failed. This can be a time consuming process since the additive manufacturing device contains serval components and a component that has failed may not be easy to identify by the visual inspection.

Once the failed component is visually identified, a replacement component may be ordered by a user. The user may manually order the replacement component, for example via a website, from the manufacturer. Once the manufacturer receives the order, the manufacturer fulfils the order and ships the replacement component to the user. This process can take several business days or more if the manufacture does not have the replacement component in stock. This can cause several more days of delays for the user. Once the replacement component arrives, the user installs the replacement component on the additive manufacturing device. As a result, the additive manufacturing device now is able to fabricate 3D objects once again.

With such a complicated and time consuming process for replacing a failed component, fabrication of 3D objects by the additive manufacturing device is significantly delayed. This can result in lost business opportunities, delays in fabrication processes; or other delay which impacts the individual user, business and and/or their customers.

Consequently, the present specification describes, among other things, a system that includes an interface to receive data from a number of sensors coupled to components of a device to monitor health of each of those components. The system also includes a processor and memory to, in response to a determination that a first of the components is to be replaced, locate an additive manufacturing device that is capable of fabrication of a replacement component without interrupting fabrication cycles of that additive manufacturing device before the first component fails and to instruct fabrication of the replacement component.

Such a system is data driven to identify components needing replacement. The determination is based on the sensor data, such as audio, vibration, video and thermal inputs monitoring the components of the device. In another example, the determination is based on a time or service life of the components of the device. As a result, a visual inspection of the components of the device may not be needed to determine if a component is about to fail or has failed.

The present specification also describes an additive manufacturing device including: an interface to receive data from a number of sensors coupled to components of the additive manufacturing device to monitor health of each of those components; and a processor and memory to, in response to a determination that a first of the components is to be replaced, determine an available time slot for the additive manufacturing device to fabricate a replacement component such that fabrication of the replacement component does not interrupt fabrication cycles of the additive manufacturing device before the first component fails and to instruct fabrication of the replacement component.

The present specification also describes a method for fabricating a replacement component including: with an interface, receiving data from a number of sensors coupled to components of a device to monitor health of each of those components; and with a processor and memory, in response to a determination that a first of the components is to be replaced, locating an additive manufacturing device that is capable of fabrication of a replacement component without interrupting fabrication cycles of that additive manufacturing device before the first component fails and to instruct fabrication of the replacement component.

In some examples, the additive manufacturing device selected to fabricate the replacement component is selected based on a geographical location of the device to the additive manufacturing device needing a replacement component. The decision is also based available time slots for an additive manufacturing device and whether an additive manufacturing device has the ability to fabricate the replacement component within specific manufacturing tolerances.

Such a system finds an available time slot of an additive manufacturing device for fabricating the replacement component that maximizes usage of the component and does not delay the fabrication of the replacement component without affecting existing fabrication schedules. As a result, the system allows the fabrication of the replacement component to be fabricated before the failure of the component and without interrupting the fabrication cycles of any additive manufacturing device.

In the present specification and in the appended claims, the term “device” means a machine that has a particular function. The device includes a number of components, such as mechanical components and/or electrical components that execute the function of the device. As will be described below, the device is an additive manufacturing device. However, in some examples, the device could be a non-additive manufacturing device. Non-additive manufacturing devices include mechanical devices, electrical devices, non 3D printers; or other devices.

In the present specification and in the appended claims, the term “health” means a level of functionality of a component. In an example, the health of a component is represented symbolically or as a range.

Examples provided herein include apparatuses, processes, and methods for generating replacement components as three-dimensional objects. Devices for generating replacement components may be referred to as additive manufacturing devices. As will be appreciated, example devices described herein may correspond to three-dimensional printing systems, which may also be referred to as three-dimensional printers. In an example, additive manufacturing process, a layer of build material may be formed in a build area, a fusing agent may be selectively distributed on the layer of build material, and energy may be temporarily applied to the layer of build material. As used herein, a build layer may refer to a layer of build material formed in a build area upon which agent may be distributed and/or energy may be applied.

Additional layers may be formed and the operations described above may be performed for each layer to thereby generate a replacement component. Sequentially layering and fusing portions of layers of build material on top of previous layers may facilitate generation of the replacement component. The layer-by-layer formation of a replacement component may be referred to as a layer-wise additive manufacturing process.

In examples described herein, a build material may include a powder-based build material, where powder-based build material may include wet and/or dry powder-based materials, particulate materials, and/or granular materials. In some examples, the build material may be a weak light absorbing polymer. In some examples, the build material may be a thermoplastic or other material such as metals. Furthermore, as described herein, agent may include fluids that may facilitate fusing of build material when energy is applied. In some examples, agent may be referred to as coalescing or fusing agent. In some examples, agent may be a light absorbing liquid, an infrared or near infrared absorbing liquid, such as a pigment colorant. In some examples at least two types of agent may be selectively distributed on a build layer. In some examples at least one agent may inhibit fusing of build material when energy is applied.

Example apparatuses may include an agent distributor. In some examples, an agent distributor may include at least one fluid ejection device. A fluid ejection device may include at least one printhead (e.g., a thermal ejection based printhead, a piezoelectric ejection based printhead, etc.). An agent distributor may be coupled to a scanning carriage, and the scanning carriage may move along a scanning axis over the build area. In one example, printheads suitable for implementation in commercially available inkjet printing devices may be implemented as an agent distributor. In other examples, an agent distributor may include other types of fluid ejection devices that selectively eject small volumes of fluid.

In some examples, an agent distributor may include at least one fluid ejection device that includes a plurality of fluid ejection dies arranged generally end-to-end along a width of the agent distributor. In some examples, the at least one fluid ejection device may include a plurality of printheads arranged generally end-to-end along a width of the agent distributor. In such examples, a width of the agent distributor may correspond to a dimension of a build area. For example, a width of the agent distributor may correspond to a width of a build area. As will be appreciated, an agent distributor may selectively distribute agent on a build layer in the build area concurrent with movement of the scanning carriage over the build area. In some example devices, the agent distributor may include nozzles including nozzle orifices through which agent may be selectively ejected. In such examples, the agent distributor may include a nozzle surface in which a plurality of nozzle orifices may be formed.

In some examples, apparatuses may include a build material distributor to distribute build material in the build area. A build material distributor may include, for example, a wiper blade, a roller, and/or a spray mechanism. In some examples, a build material distributor may be coupled to a scanning carriage. In these examples, the build material distributor may form build material in the build area as the scanning carriage moves over the build area along the scanning axis to thereby form a build layer of build material in the build area.

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present device, systems, and methods may be practiced without these specific details. Reference in the specification to “an example” or similar language means that a particular feature, structure, or characteristic described in connection with that example is included as described, but may not be included in other examples.

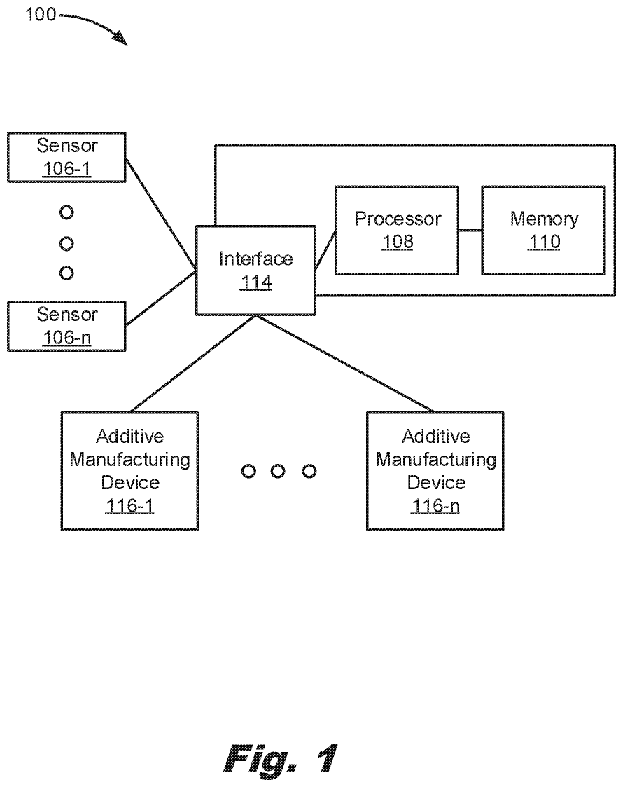

Now referring to the figures. FIG. 1 is a diagram of a system for fabricating a replacement component for a device, according to one example consistent with the disclosed implementations. As will be described below, the system (100) includes a number of sensors (106) to monitor components of a device. The system (100) includes additive manufacturing devices (116) to fabricate a replacement component for a component of the device that needs replacing.

As illustrated, the system (100) includes an interface (114). The interface (114) receives data from the number of sensors (106) coupled to components of a device to monitor health of each of those components.

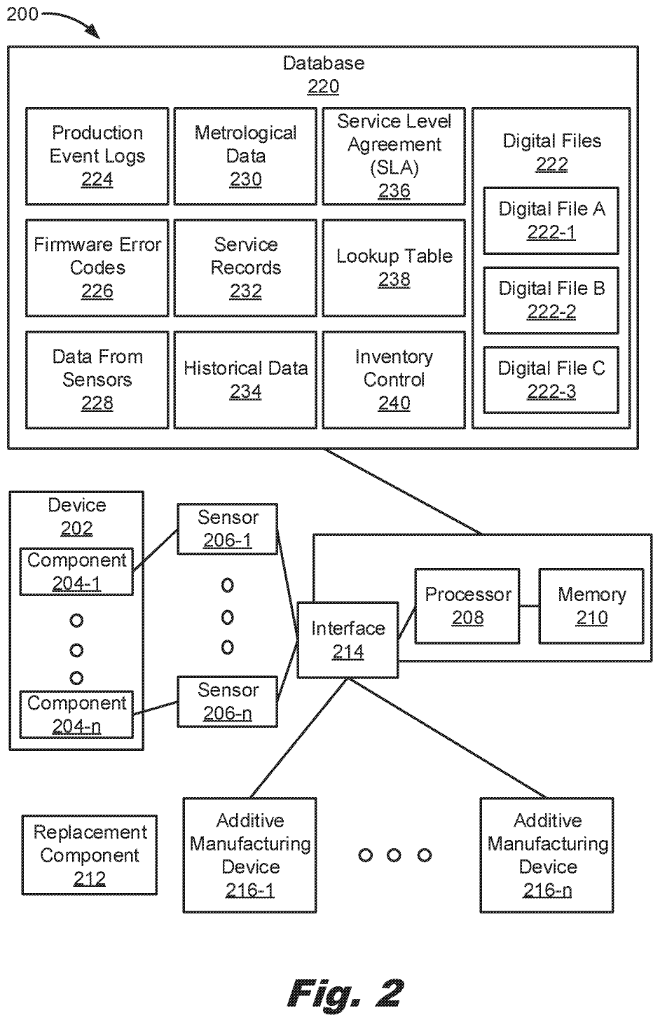

The system (100) includes a processor (108) and memory (110). The processor (108) and memory (110), in response to a determination that a first of the components is to be replaced, locate an additive manufacturing device (116) that is capable of fabrication of a replacement component without interrupting fabrication cycles of that additive manufacturing device (116) before the first component fails and to instruct fabrication of the replacement component. A more detailed version of this system (100) will be described in FIG. 2.

FIG. 2 is a diagram of a system for fabricating a replacement component for a device, according to one example consistent with the disclosed implementations. As mentioned above, the system (200) of FIG. 2 is a more detailed version of the system (100) of FIG. 1. As will be described below, the system (200) includes a database (220), a device (202) with a number of components (204) and sensors (206) coupled to the components (204). The system (200) includes an interface (214) to receive data from the sensor (206), a processor (208) and memory (210) to provide functionality to the system (200), and a number of additive manufacturing devices (216) to fabricate a replacement component (212).

As illustrated, the system (200) includes a device (202). The device (202) is a machine that has a particular function. In the example of FIG. 2, the device (202) is an additive manufacturing device. As will be described below, the device (202) is unable to fabricate a replacement component (212) for itself. As a result, one of the additive manufacturing devices (216) is selected to fabricate the replacement component (212). However, in other parts of this specification, the device (202) is able to fabricate a replacement component (212) for itself.

The device (202) includes a number of components (204), such as mechanical or electrical components that execute the function of the device (202). For example, the components (204) are mechanical in nature and provide functionality to the desired operation of the device (202). This includes handles, covers, ducting, brackets, structural elements, plenums, and other components. Because these components (204) are mechanical in nature, the components (204) are subject to wear and tear. If the wear and tear becomes substantial, the component (204) will fail. As a result, when one of the components (204) fail, the device (202) can no longer function as intended. In this example, the replacement component (212) is fabricated as a 3D object.

Several of these components (204) of the device (202) are fabricated via an additive manufacturing device at time of manufacture. As will be described below, as these components (204) need replacement, an individual that owns the device (202) and/or has an additive manufacturing device (216) can fabricate replacement components for the device (202). In other examples, a third party that has an additive manufacturing device (216) can fabricate replacement components for the device (202).

As illustrated, the system (200) includes a number of sensors (206). The sensors (206) are for example temperature sensors, humidity sensors, tactile sensors, force-resisting sensors, noise sensor, chemical sensors, image sensors, thermal sensors, vibration sensors, Hall Effect sensors or other sensors. The sensors (206) are coupled to the components (204) of the device (202) to monitor health of each of those components (204) in the form of data.

The health is a level of functionality of a component. In an example, the health of a component is represented symbolically, such as high, medium, low. A health of a component that is high indicates the component is functioning as intended. A health of a component that is medium indicates the component is functioning, but does have some wear and tear. A health of a component that is low indicates the component is about to fail and should be replaced soon.

In another example, the health of a component is represented as a range. For example, a range of 0 to 10, where 0 indicates the component is about to fail and should be replaced soon and 10 indicates the component is functioning as intended.

In some examples, a sensor directly monitors the health of the components (204). For example, a temperature sensor (206-1) can be in direct contact with a component (204-1) that is sensitive to heat. If the temperature sensor (206-1) determines the component (204-1) is exposed to too much heat, the temperature sensor (206-1) sends data to an interface (214) specifying the health of the component is low. Since the health is low for the component (204-1), the component (204-1) will need to be replaced.

In other examples, a sensor indirectly monitors the health of the components (204). For example, a Hall Effect sensor (206-2) keeps track of how many times a component (204-2) is inserted and removed from the device (202). Each time the component (204-2) is inserted and removed from the device (202), the component (204-2) and other components in contacted with the component (204-2) experiences wear and tear. If the Hall Effect sensor (206-2) indicates the component (204-2) is inserted and removed from the device (202) too many times, the Hall Effect sensor (206-2) sends data to the interface (214) specifying the health of the component (204-2) is low. Since the health is low for the component (204-2), the component (204-2) and the other components in contact with the component (204-2) will need to be replaced.

The system (200) includes the interface (214). The interface (214) is a combination of hardware and program instructions designed to perform a designated function. The interface (214) includes a processor and memory. The program instructions are stored in the memory and cause the processor to execute the designated function of the interface (214). The interface (214) receives data from the number of sensors (206) coupled to the components (204) of the device (202) to monitor health of each of those components (204). Data from the sensors (206) are read by the interface (214) as a time series based on a sliding window. This allows the data to be read and/or tracked in a chronological order that is time stamped. The data read from heterogeneous sensors is aligned temporally and spatially. In some examples, the heterogeneous sensors are sensors that are dissimilar. This includes aspects such as communication ranges, sensing ranges, other aspects, or combinations thereof. Data (228) from the sensors is stored in a database (220).

The interface (214) further receives the data from production event logs (224) stored in the database (220). The production event logs (224) record all events of the device (202) and are time stamped with a start time and a stop time. For example, the production event logs (224) include job descriptions, job identification numbers and times of those jobs for the device (202). The production event logs (224), in combination with the data from the sensors (206), are used to determine how many times a component can be used and is used before the component fails. If the production event logs (224) indicate a component is used often, a determination can be made indicating when to replace that component.

The interface (214) further receives the data from metrological data (230) stored in a database (220). Metrological data (230) includes the function and/or performance of a component within the device (202). This includes if the device (202) fabricated a product accurately. If the metrological data (230), in combination with the data from the sensors (206), indicates the health of the component is declining because the device (202) is not fabricating a product accurately, a determination can be made indicating when to replace that component. As a result, the metrological data (230) is used to further determine the health of a component.

Further, the interface (214) receives the data from firmware error codes (226) stored in a database (220). The firmware error codes (226) include data about errors that the device (202) encounters during operation. The firmware error codes (226), in combination with the data from the sensors (206), are used to determine the health of a component. If the firmware error codes (226) indicate the health of a component is declining because an error is occurring with that component during operation of the device (202), a determination can be made indicating when to replace that component. As a result, the firmware error codes (226) are used to further determine the health of a component.

In another example, the interface (214) receives the data from historical data (234) stored in a database (220). Historical data (234) includes information about the life expectancy for each of the components (204). This information is based off of testing of the device (202) during the development stage. For example, if the testing of the device (202) during the development stage indicates a component can be inserted and removed 100,000 times before the component fails, the historical data (234) for that component indicates that the component is to be replaced before that component is inserted and removed 100,000 times. If the historical data (234), in combination with the data from the sensors (206), indicates the health of the component is low because the sensors (206) indicate component has been inserted and removed almost 100,000 times, a determination can be made indicating when to replace that component. As a result, the historical data (234) is used to further determine the health of a component.

The interface (214) receives the data from service records (232) stored in a database (220). The service records (232) indicate when the components (204) were last replaced or serviced. If the service records (232) indicate a component was last serviced 3 months ago and the component is to be replaced every 3 months, the service records indicate that the component is to be replaced. As a result, preventive maintenance schedules can be used to trigger fabrication of replacement components.

In an example, the interface (214) analyzes this data from the sensors (206) in combination with the information stored in the database (220) to determine whether the degradation in a component's performance is due to wear and tear. In an example, a Kalman filter is used to merge the data of the sensors (206) to determine the health of the components of the device (202). A Kalman filter is a linear quadratic estimation algorithm that uses a series of measurements (i.e. data from the sensors (206) observed over time, containing statistical noise and inaccuracies and produces estimates of failure times for the component that the sensors (206) monitor.

An example, of why the Kalman filter is used will now be described given the device (202) is an additive manufacturing device. The state of the device (202) is given by a list of process variables, components being fabricated, and the powder used for the fabrication. A prediction of what the future states of the device (202) is made by transforming state variables based on the property of the device (202).

This prediction doesn't consider the ground truth. As a result, the sensors (206) are used to indirectly measure the state. For example, a thermal sensor camera is capturing an image of the build area of the device (202). A profilometer is used for capturing the thickness of each of the layers as the device fabricates 3D objects. If the camera is a low resolution camera, there might be inaccurate measurements of the desired 3D object. Both the thermal sensor and the profilometer are capturing states, but indirectly. Occasionally, the camera won't trigger at the right moment. At other times the camera may change its field of view due to adjustments to the build area. So sensor measurement alone won't give the right prediction either.

When less powder is dispensed (due to clogging) of powder ducts, the thickness of the layers is seen and the resultant part density. At these points, the observations from the profilometer and the thermal cameras are consistent and predicting that it is close to accurate. Known correlations, such as tensile stress positively correlated to the maximum temperature and layer thickness positively correlated to part density.

With the Kalman filters, the data from the sensors (206) is fused together and is combined with the known properties, known and unknown disturbances and known correlations to predict the future state of the device (202). A record of the current state variables, current sensor measurements, the covariance matrix of the state variables, the sensor measurements and the known effect of external forces to state variables (such as the effect of convective air on cooling of a part or reduction in flow ability due to mixing recycling powder with the fresh powder) to predict now a range of states is kept. Data fusion occurs in a centralized fashion using the optimal Kalman filter or extended Kalman filter if the processes involved are non-linear. This determination can be done remotely by the interface (214) or by a third party.

The system (100) further includes a processor (208) and memory (210). The processor (208) and the memory (210), in response to a determination that a first of the components (204) is to be replaced, locates an additive manufacturing device (216) that is capable of fabrication of a replacement component (212) without interrupting fabrication cycles of that additive manufacturing device (216) before the first component fails and to instruct fabrication of the replacement component (212).

For example, if sensor 206-1 is monitoring the health of component 204-1 and determines the health of component 204-1 is low, it is determined that component 204-1 is to be replaced because the health of component 204-1 is low. Service records (232) and historical data (234) from other installations are compared to determine the remaining time to failure and a timeframe for replacement is determined. The timeframe indicates, for example, component 204-1 is to be replaced within a specified time, such as within the next three days.

The processor (208) and the memory (210) determine if a replacement component (212) has to be fabricated via one of the additive manufacturing devices (216). This can be as simple as accessing a table lookup (238) in the database (220) or making application programming interface (API) calls to inventory control (240) stored in the database (220) to lookup inventory in a warehouse. Multiple factors such as geographical location of the device (202), contract provisions, warranties, required software assets among others are used to determine whether the replacement component (212) fabricated via one of the additive manufacturing devices (216) is appropriate. Using the device's serial number and a management information system (MIS) the faulty component manufacturing method is traced and determined whether it was originally fabricated via an additive manufacturing device or came from conventional manufacturing. If the component was originally fabricated via conventional manufacturing, the system (200) indicates, for example, via a display, that the component was fabricated via conventional manufacturing and how to order a replacement part via the manufacturer.

If the component was originally fabricated via an additive manufacturing device, the processor (208) and the memory (210) locates an additive manufacturing devices (216) that are capable of the fabrication of the replacement component (212) without interrupting the fabrication cycles of the additive manufacturing devices (216) before the first component fails by determining a geographical location of the first component. In some examples, a GPS tracking unit is attached to the device (202) to determine the location of the device (202). In other examples, the last known mailing address of the device (202) is used to determine the location of the device (202). Other methods may be used to determine the location of the device (202).

Based on the geographical location of the first component, the processor (208) and the memory (210) determine additive manufacturing devices (216) capable of fabricating the replacement component (212) without reducing quality of the replacement component. This includes comparing the failed component's original additive manufacturing device and available additive manufacturing devices. In some examples, this comparison includes how accurately a given additive manufacturing device can fabricate the replacement component (212). In other examples, this includes a fabrication process for a given additive manufacturing device.

If available additive manufacturing devices (216) are different from the original additive manufacturing device, capabilities of the additive manufacturing devices are considered for the fabrication of the replacement component (212). If the capabilities of the additive manufacturing devices (216) are such that the replacement component (212) can be fabricated, customer and service technician can negotiate on what the mechanical property, surface finish trade-offs for the replacement component (212) will be. If both parties agree, then the replacement component (212) can be fabricated.

The processor (208) and the memory (210) determine, based on a pareto-optimization, available time slots of the additive manufacturing device for the fabrication of the replacement component (212). Pareto-optimization is an algorithm that optimizes a solution given many parameters. Pareto-optimization is preferable due to the multiple criteria decision making needed (i.e. which additive manufacturing device to select and which time slot to select). For pareto-optimization, a version of a non-dominated sorting genetic algorithm-II (NSGA-II) algorithm is used to solve multi-objective constraint problems to find a pareto-optimal front that contains a number of pareto-optimal solutions. The pareto-optimal solutions are better than other solutions when all objectives are considered. However, pareto-optimal solutions are inferior to other solutions in one or more objectives. The solutions in the pareto-optimal front are ranked with respect to the time left from the availability of the component and the estimated time for failure of the component. Other considerations for pareto-optimization could be the kind of material used to fabricate the replacement component (212) and the criticality of that component to pick an additive manufacturing device (216) that is the best for a given component.

In an example, a time to completion determination is made from a lookup table which is part of the digital file stored in the database (220). If there is an additive manufacturing device and there is an available time slot large enough to fabricate the replacement component (212), then that job is assigned to that additive manufacturing device. The pareto-optimization algorithm is used to opportunistically find an available time slot that maximizes the usage of the component yet minimizes the chances of not having an available time slot if its fabrication is delayed too much.

The processor (208) and the memory (210) select the additive manufacturing device to fabricate the replacement component during one of the available time slots. If processor (208) and the memory (210) cannot find a suitable additive manufacturing device or a slot to fabricate the replacement component, then the processor (208) and the memory (210) can pursue other options. This can include having the original manufacturer fabricate the replacement component (212).

The processor (208) and the memory (210) further determine if a service level agreement (SLA) is violated before the fabrication of the replacement component (212). SLA violations include too great of a downtime for the device (202), jeopardizing production of products if the device (202) is a manufacturing device, among other SLA violations.

The processor (208) and the memory (210) further schedules a service appointment with a technician to install the replacement component (212) in the device based on a completion time of the fabrication of the replacement component (212). For example, once the replacement component (212) is injected into the fabrication stream for the selected additive manufacturing device, a service technician is informed of the time estimates for the replacement component (212) will be ready. The replacement component (212) is fabricated and both the customer and service technician are alerted. Any post-processing instructions are also conveyed to a service bureau to minimize service technician's time in installing the replacement component (212).

In addition to storing the data described above, the database (220) stores a number of digital files (222). The digital files (222) corresponding to machine-readable instructions for the fabrication of the replacement component (212). In an example, the digital files (222) are CAD models representing components (204) of the device (202). The additive manufacturing devices (216) are able to fabricate the replacement component (212) via one of the digital files (222). In an example, if it is determined that component 204-1 is to be replaced, digital file A (222-1), corresponding to component 204-1, is sent to the interface (214) to instruct fabrication of the replacement component (212) via the selected additive manufacturing device. As a result, a cloud service provides access to digital files for fabricating the replacement component (212)

As mentioned above, the system (100) includes a number of additive manufacturing devices (216). At least one of the additive manufacturing devices (216) is selected to fabricate a replacement component (212) for the device (202). The additive manufacturing device fabricates the replacement component (212) by depositing layers of build material corresponding to slices of a CAD model of the digital file (222) that represents the replacement component (212).

In some examples, a physical location of the additive manufacturing devices (216) to the device (202) is a local location or a remote location. For example, additive manufacturing device 216-1 is local to the device (202). In other words additive manufacturing device 216-1 is located in the same building as the device (202). Additive manufacturing device 216-2 is remote to the device (202). In other words additive manufacturing device 216-2 is located in a building outside of the building of the device (202). As a result, the location of the additive manufacturing devices (216) is taken into consideration when selecting one of the additive manufacturing devices (216) to fabricate the replacement component (212).

An overall example, of FIG. 2 will now be described. The interface (214) receive data from the number of sensors (206) coupled to the components (204) of the device (202) to monitor health of each of those components (204). In this example, the device (202) is an additive manufacturing device that is unable to fabricate a replacement component (212) for itself due to its fabrication schedule.

The interface (214) analyzes the data and/or the information from the database (202) to determine the health of the components (204). The interface (214) determines the health of component 204-1 is low. As a result, a determination is made that component 204-1 is to be replaced. The interface (214) further determines that component 204-1 can be fabricated via one of the additive manufacturing devices (216).

The processor (208) and the memory (210) to, in response to a determination that component 204-1 is to be replaced, locate one of the additive manufacturing devices (216) that is capable of fabrication of a replacement component (212) without interrupting fabrication cycles of that additive manufacturing device (216-1) before component 204-1 fails and to instruct fabrication of the replacement component (212). In this example, the replacement component (212) for component 204-1 takes 10 minutes to fabricate and the available time slot for additive manufacturing device 216-1 to fabricate a replacement component (212) is at 1:00 PM. Once the replacement component (212) is fabricated, a service technician is alerted to install the replacement component (212).

While this example has been described with reference to the processor (208), memory (210) and interface (214) being located in a separate module, the processor (208), memory (210), interface (214) or combinations thereof may be located in any appropriate location according to the principles described herein. For example, the processor (208), memory (210), interface (214) or combinations thereof may be located in on the additive manufacturing devices (216), on the device (202), in the database (220), other locations, or combinations thereof.

While this example has been described with reference to the device (202) being an additive manufacturing device, the device could be another type of device. This includes non-3D printers, mechanical devices, or other devices that include components that can be fabricated by an additive manufacturing device.

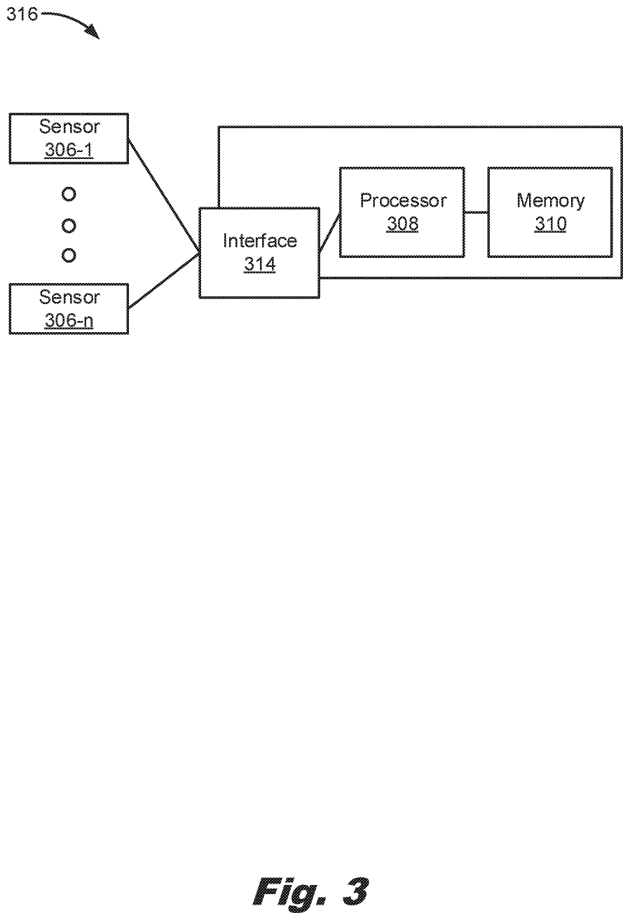

FIG. 3 is a diagram of a system for fabricating a replacement component for an additive manufacturing device, according to one example consistent with the disclosed implementations. As will be described below, the additive manufacturing device (316) includes a number of sensors (306) monitoring components of the additive manufacturing device (316). The additive manufacturing device (316) fabricates a replacement component for a component of the additive manufacturing device (316) that needs replacing.

As illustrated, the additive manufacturing device (316) includes an interface (314). The interface (314) receives data from a number of sensors (306) coupled to components of the additive manufacturing device (316) to monitor health of each of those components.

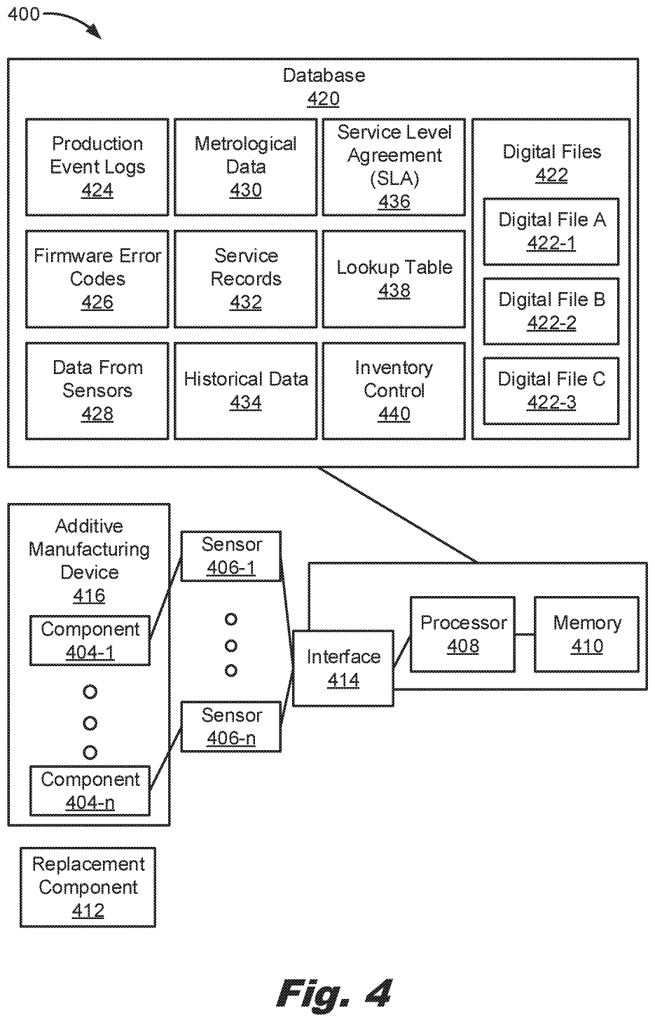

The additive manufacturing device (316) includes a processor (308) and memory (310) to, in response to a determination that a first of the components is to be replaced, determine an available time slot for the additive manufacturing device (316) to fabricate a replacement component such that fabrication of the replacement component does not interrupt fabrication cycles of the additive manufacturing device (316) before the first component fails and to instruct fabrication of the replacement component (312). A more detailed version of this will be described in FIG. 4.

FIG. 4 is a diagram of a system for fabricating a replacement component for an additive manufacturing device, according to one example consistent with the disclosed implementations. As will be described below, the system (400) includes a database (420), an additive manufacturing device (416) with a number of components (404) and sensors (406) coupled to the components (404). The system (400) includes an interface (414) to receive data from the sensor (406), a processor (408) and memory (410) to provide functionality to the system (400). The additive manufacturing device (416) fabricates a replacement component (412) for itself.

As illustrated, the system (400) includes an additive manufacturing device (416). The additive manufacturing device (416) includes a number of components (404), such as mechanical or electrical components that execute the function of the additive manufacturing device (416). For example, the components (404) are mechanical in nature and provide functionality to the desired operation of the device (416). This includes handles, covers, ducting, brackets, structural elements, plenums, and other components. Because these components (404) are mechanical in nature, the components (404) are subject to wear and tear due to repeated use. If the wear and tear becomes substantial, the component (404) can fail. As a result, when the components (404) fail the additive manufacturing device (416) can no longer function as intended.

As illustrated, the system (400) includes a number of sensors (406). The type of sensors is the same as described above. The sensors (406) are coupled to the components (404) of the additive manufacturing device (416) to monitor health of each of those components (404) in the form of data. For example, a sensor tracks the number of cycles of a carriage and a duct or bracket on the carriage would need to be replaced at a set interval to reduce possibility of fatigue failure or build-up of powder within the duct. In this example, the replacement component will need to be fabricated before one million cycles of the carriage.

The system (400) includes an interface (414). The interface (414) receives data from the number of sensors (406) coupled to the components (404) of the additive manufacturing device (416) to monitor health of each of those components (404) as described above. Data (428) from the sensors is stored in a database (420).

The interface (414) receives the data from production event logs (424) stored in the database (420). The production event logs (424) record all events of the additive manufacturing device (416) that are time stamped with a start time and a stop time.

In an example, the interface (414) receives the data from metrological data (430) stored in a database (420). Metrological data (430) includes the function and/or performance of a component that the additive manufacturing device (416) fabricated. This includes if the additive manufacturing device (416) fabricated a component accurately.

The interface (414) receives the data from firmware error codes (426) stored in a database (420). The firmware error codes (426) include data about errors that the additive manufacturing device (416) encounters during operation.

The interface (414) receives the data from historical data (434) stored in a database (420). Historical data (434) includes information about the life expectancy for each of the components (404). This information is based off of testing of the device (404) during the development stage of the additive manufacturing device (416) as described above.

In an example, the interface (414) receives the data from service records (432) stored in a database (420). The service records (432) indicate when the components (404) were last replaced or serviced. In an example, preventive maintenance schedules can be used to trigger fabrication of replacement components. For example a component wears out as a function of hours of operation. An internal clock would be able to provide the hours of operation for a component. As a result, some components are replaced based on time or service life rather than sensor data.

The interface (414) analyzes this data, from the sensors (406) and the database (420), to determine whether the degradation in component quality is due to wear and tear. As mentioned above, a Kalman filter is used to merge the data of the sensors to determine the health of the components of the device. Data fusion occurs in a centralized fashion using the optimal Kalman filter or extended Kalman filter if the processes involved are non-linear. This determination can be done remotely either by the interface (414) or by a third party.

The system (400) includes a processor (408) and memory (410). The processor (408) and the memory (410), in response to a determination that a first of the components is to be replaced, determine an available time slot for the additive manufacturing device (416) to fabricate a replacement component (412) such that fabrication of the replacement component (412) does not interrupt fabrication cycles of the additive manufacturing device (416) before the first component fails and to instruct fabrication of the replacement component (412).

For example, if sensor 406-1 is monitoring the health of component 404-1 and determines the health of component 404-1 is declining, it is determined that component 404-1 is to be replaced. Service records (432) and historical data (434) from other installations are compared to determine the remaining time to failure and a timeframe for replacement is determined.

The processor (408) and the memory (410) determine if a replacement component (412) has to be fabricated via the additive manufacturing device (416). This can be as simple as accessing a lookup table (438) in the database (420) or making API calls to inventory control (440) stored in the database (420) to lookup inventory in a warehouse as described above.

The processor (408) and the memory (410) determine, based on a pareto-optimization, available time slots of the additive manufacturing device (416) for the fabrication of the replacement component (412) as described above. The processor (408) and the memory (410) further determine if a service level agreement (SLA) is violated before the fabrication of the replacement component as described above. The processor (408) and the memory (410) further schedules a service appointment with a technician to install the replacement component in the device based on a completion time of the fabrication of the replacement component as described above.

The system (400) includes the database (420). In addition to storing the data described above, the database (420) stores a number of digital files (422). The digital files (422) corresponding to machine-readable instructions for the fabrication of the replacement component (412). For example, if component 404-1 is to be replaced, digital file A (422-1), corresponding to component 404-1, is sent to the interface (414) to instruct fabrication of the replacement component (412).

The additive manufacturing device (416) fabricates the replacement component (412) by depositing layers of build material corresponding to slices of a CAD model of the digital file (422) that represents the replacement component (412). Such a system is data driven to identify components needing replacement. The determination is based on the multi-sensor, such as audio, video, vibration and thermal inputs monitoring the components of the device. In another example, the determination is based on a time or service life of the components of the device. As a result, the additive manufacturing device (416) fabricates the replacement component (412) for itself using its own fabrication materials.

Such a system (400) finds an available time slot of the additive manufacturing device (416) for fabricating the replacement component (412) that maximizes usage of the component and does not delay the fabrication of the replacement component (412) without affecting existing fabrication schedules. As a result, the system (400) allows the fabrication of the replacement component (412) to be fabricated before the failure of the component and without interrupting the fabrication cycles of the additive manufacturing device (416).

An overall example, of FIG. 4 will now be described. The interface (414) receive data from the number of sensors (406) coupled to the components (404) of the additive manufacturing device (416) to monitor health of each of those components (404).

The interface (414) analyzes the data and/or the information from the database (420) to determine the health of the components (404). The interface (414) determines the health of component 404-1 is low. As a result, a determination is made to replace component 404-1. The interface (414) further determines that component 404-1 can be fabricated via the additive manufacturing device (416).

The processor (408) and the memory (410) to, in response to a determination that component 404-1 is to be replaced, determine an available time slot for the additive manufacturing device (416) to fabricate a replacement component (412) such that fabrication of the replacement component (412) does not interrupt fabrication cycles of the additive manufacturing device (416) before component 404-1 fails and instructs fabrication of the replacement component (412). In this example, a replacement component for component 404-1 takes 10 minutes to fabricate and the available time slot for the additive manufacturing device (416) to fabricate a replacement component (412) is at 1:00 PM. Once the replacement component (412) is fabricated, a service technician is alerted to install the replacement component (412).

While this example has been described with reference to the processor (408), memory (410) and interface (414) being located in a separate module, the processor (408), memory (410), interface (414) or combinations thereof may be located in any appropriate location according to the principles described herein. For example, the processor (408), memory (410), interface (414) or combinations thereof may be located in the additive manufacturing devices (416), in the database (420), other locations, or combinations thereof.

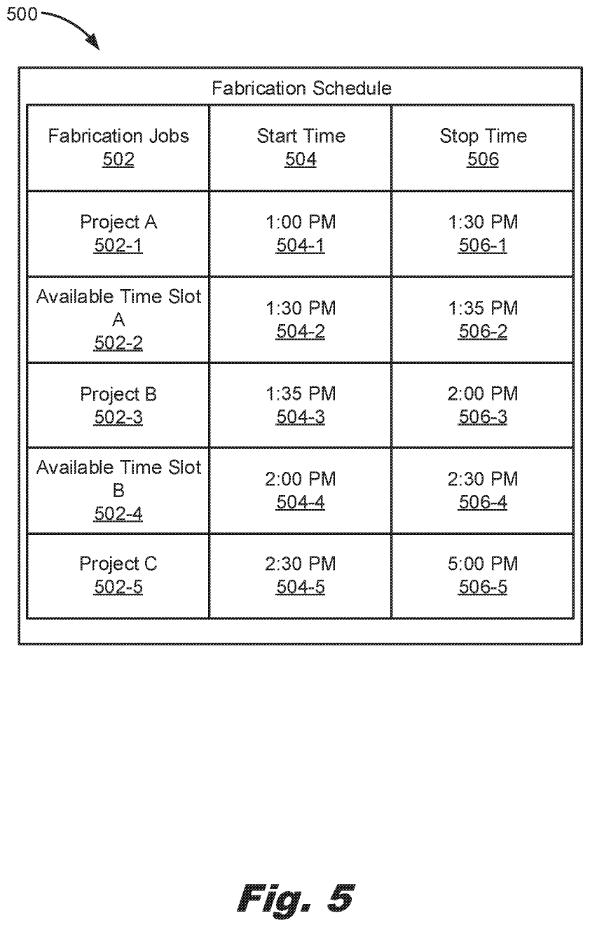

FIG. 5 is a diagram of a fabrication schedule, according to one example consistent with the disclosed implementations. As will be described below, the fabrication schedule (500) includes fabrication jobs (502) with start times (504) and stop times (506) for the fabrication jobs (502).

As illustrated, the fabrication schedule (500) includes fabrication jobs (502). The fabrication jobs (502) include project A (502-1), project B (502-3) and project C (502-5).

Each of the fabrication jobs (502) includes a start time (504) and a stop time (506). For example, project A (502-1) has a start time of 1:00 PM (504-1) and a stop time of 1:30 PM (506-1). During these times (504-1 and 506-1) the additive manufacturing device cannot fabricate a replacement component.

Project B (502-3) has a start time of 1:35 PM (504-3) and a stop time of 2:00 PM (506-3). During these times (504-3 and 506-3) the additive manufacturing device cannot fabricate a replacement component. However, because the additive manufacturing device is not in use from 1:30 PM (504-2) to 1:35 PM (506-2), available time slot A (502-2) is indicated for the fabrication schedule (500). During available time slot A (502-2) a replacement component can be fabricated by the additive manufacturing device if the additive manufacturing device can fabricate the replacement component during these times (504-2 and 506-2).

Project C (502-5) has a start time of 2:30 PM (504-5) and a stop time of 5:00 PM (506-5). During these times (504-5 and 506-5) the additive manufacturing device cannot fabricate a replacement component. However, because the additive manufacturing device is not in use from 2:00 PM (504-4) to 2:30 PM (506-4), available time slot B (502-4) is indicated for the fabrication schedule (500). During available time slot B (502-4) a replacement component can be fabricated by the additive manufacturing device if the additive manufacturing device can fabricate the replacement component during these times (504-4 and 506-4).

As mentioned above, pareto-optimization is used to determine available time slots of the additive manufacturing device for the fabrication of the replacement component. The available time slot for the additive manufacturing device is determined by determining all available time slots for the additive manufacturing device. In this example, available time slot A (502-2) and available time slot B (502-4).

The available time slot for the additive manufacturing device is determined by determining a duration of each of the available time slots. The duration of time for available time slot A (502-2) is 5 minutes. The duration of time for available time slot B (502-4) is 30 minutes.

Further, the available time slot for the additive manufacturing device is determined by determining a length of time for the fabrication of the replacement component. In an example, the replacement component takes less than 4 minutes to fabricate.

Based on a comparison of the duration of each of the available time slots and the length of time for the fabrication of the replacement component, the available time slot is selected. As a result, the replacement component could be fabricated during available time slot A (502-2) or available time slot B (502-4). Since the component that needs replacing is expected to fail before 2:00 PM, as indicated by the health, the replacement component is fabricated during time slot A (502-2). However, if the component that needs replacing is expected to fail after 5:00 PM, as indicated by the health, the replacement component is fabricated during time slot B (502-4).

The pareto-optimization takes into consideration the business objectives associated with the fabrication of the replacement component. For example, if the additive manufacturing device is used for a business that occasionally uses the additive manufacturing device, the replacement component could be fabricated right away. As a result, available time slot A (502-2) is used for the fabrication of the replacement component.

However, if the additive manufacturing device is used for a factory that constantly uses the additive manufacturing device, the replacement component could be fabricated during a last available time slot. As a result, available time slot B (502-4) is used for the fabrication of the replacement component.

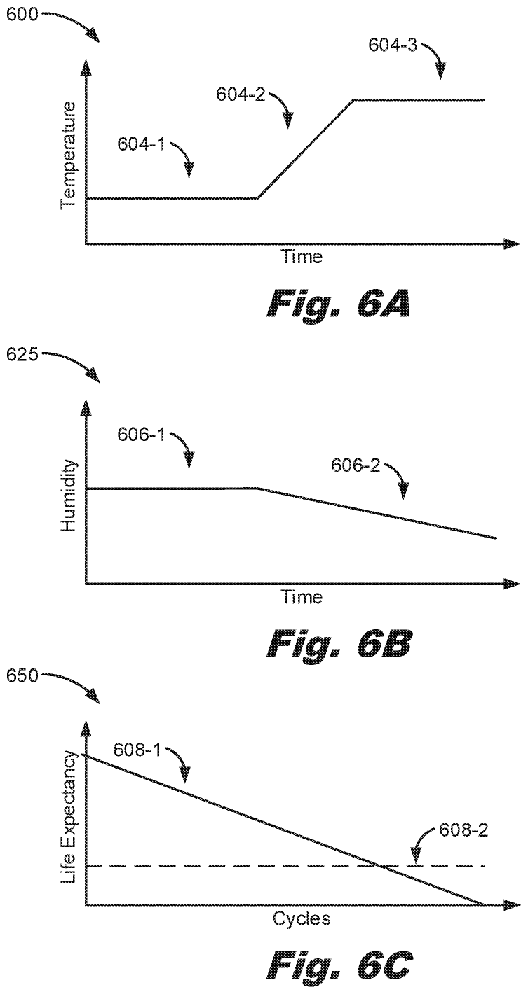

FIG. 6A is a diagram of a sensor monitoring temperature, according to one example consistent with the disclosed implementations. As will be described below, the sensor monitors the temperature of a component.

In the diagram (600), line 604-1 illustrates the normal temperature of the component. During this time frame, the health of the component is high. As the component is used more, the temperature of the component rises, as indicated by line 604-2, due to wear and tear. During this time frame, the health of the component is decreasing. Once the wear and tear is substantial, the temperature of the component is high, as indicated by line 604-3. During this time frame, the health of the component is low. As a result, the component needs replacement as indicated by the data for this sensor.

FIG. 6B is a diagram of a sensor monitoring humidity, according to one example consistent with the disclosed implementations. As will be described below, the sensor monitors the humidity of a component. As the humidity decreases, this indicates the component is failing and needs to be replaced.

In the diagram (625), line 606-1 illustrates the normal humidity of the component. During this time frame, the health of the component is high. As the component is used more, the humidity of the component lowers, as indicated by line 606-2, due to wear and tear (i.e. humidity escaping out of the component). During this time frame, the health of the component is decreased from high to low. As a result, the component needs replacement as indicated by the data for this sensor.

FIG. 6C is a diagram monitoring life expectancy of a component, according to one example consistent with the disclosed implementations. As will be described below, a sensor monitors the number of times a carriage travels along a rod.

The diagram (650) illustrates the life expectancy of components for a carriage verses the number of times the carriage travels along a rod of the carriage. As the carriage travels along the rod, the life expectancy of the components for the carriage decline as indicated by arrow 608-1. A sensor tracks the number of cycles of the carriage and a duct or bracket on the carriage would need to be replaced at a set interval to reduce possibility of fatigue failure or build-up of powder within the duct. This interval is illustrated as dashed line 608-2. In this example, the replacement component will need to be fabricated before one million cycles of the carriage.

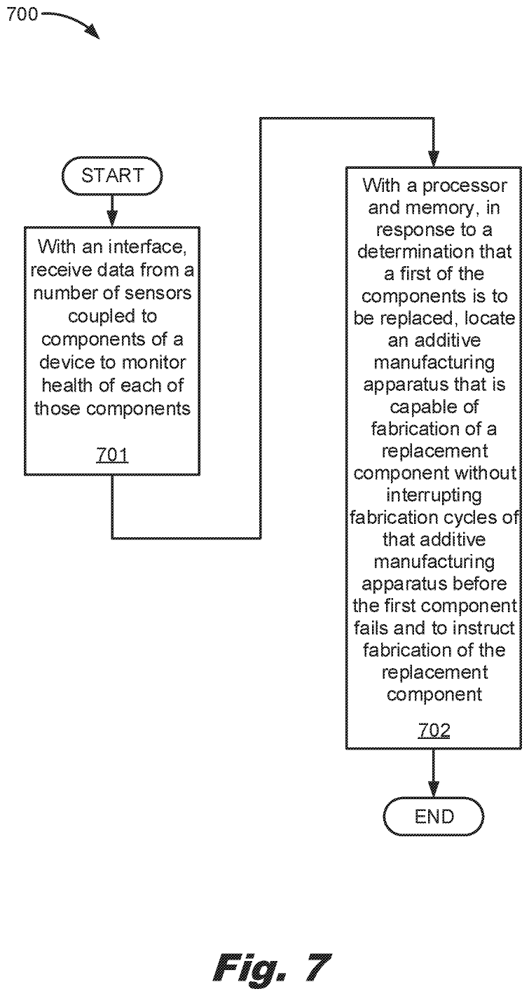

FIG. 7 is a flowchart a method for fabricating a replacement component, according to one example consistent with the disclosed implementations. The method (700) is executed by the system (100) of FIG. 1. The method (700) is executed by other systems such as system 200, system 300 or system 400. In this example, the method (700) includes with an interface, receiving (701) data from a number of sensors coupled to components of a device to monitor health of each of those components and with a processor and memory, in response to a determination that a first of the components is to be replaced, locating (702) an additive manufacturing device that is capable of fabrication of a replacement component without interrupting fabrication cycles of that additive manufacturing device before the first component fails and to instruct fabrication of the replacement component.

As mentioned above, the method (700) includes with an interface, receiving (701) data from a number of sensors coupled to components of a device to monitor health of each of those components. In some examples, the sensors directly monitor the health of each of those components. In other examples, the sensors indirectly monitor the health of each of those components. Further, information stored in a database is used to determine the health of each of those components.

As mentioned above, the method (700) includes with a processor and memory, in response to a determination that a first of the components is to be replaced, locating (702) an additive manufacturing device that is capable of fabrication of a replacement component without interrupting fabrication cycles of that additive manufacturing device before the first component fails and to instruct fabrication of the replacement component.

In some examples, if the method (700) locates more than one additive manufacturing device, the method (700) optimizes the selection of the additive manufacturing device. This includes selecting the additive manufacturing device that has a geographical location closest to the device, selecting the additive manufacturing device that has the soonest available time slot, selecting the most compatible additive manufacturing device, or combinations thereof.

In some examples, the method (700) determines a type of additive manufacturing device that originally manufactured the component. If an additive manufacturing device that originally manufactured the component has an available time slot, that additive manufacturing device is instructed to fabricate the replacement component. If a comparable additive manufacturing device has an available time slot, that additive manufacturing device is instructed to fabricate the replacement component. If no additive manufacturing device has an available time slot, a manufacture may fabricate the replacement component.

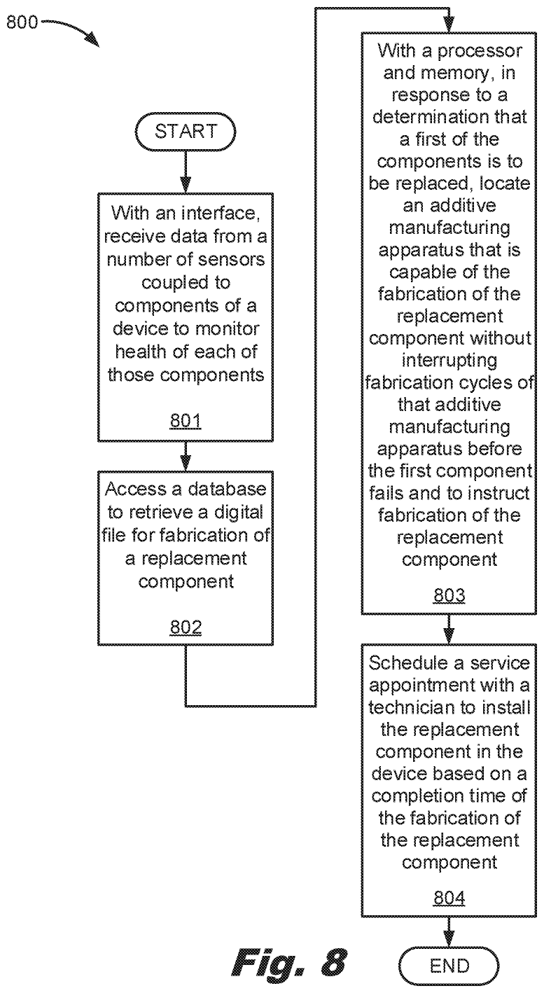

FIG. 8 is a flowchart of a method for fabricating a replacement component, according to one example consistent with the disclosed implementations. The method (800) is executed by the system (100) of FIG. 1. The method (800) is executed by other systems such as system 200, system 300 or system 400. In this example, the method (800) includes with an interface, receiving (801) data from a number of sensors coupled to components of a device to monitor health of each of those components, accessing (802) a database to retrieve a digital file for fabrication of a replacement component, with a processor and memory, in response to a determination that a first of the components is to be replaced, locating (803) an additive manufacturing device that is capable of the fabrication of the replacement component without interrupting fabrication cycles of that additive manufacturing device before the first component fails and to instruct fabrication of the replacement component and scheduling (804) a service appointment with a technician to install the replacement component in the device based on a completion time of the fabrication of the replacement component.

As mentioned above, the method (800) includes accessing (802) a database to retrieve a digital file for fabrication of a replacement component. As mentioned above, the database stores a number of digital files that correspond to computer readable instruction for fabricating a replacement component. The method (800) uses a lookup table to determine the correct digital file from the database for fabricating the replacement component.

As mentioned above, the method (800) includes scheduling a service appointment with a technician to install the replacement component in the device based on a completion time of the fabrication of the replacement component. For example, if the completion time of the fabrication of the replacement component is 5:00 PM, the method (800) schedules a service appointment with a technician to install the replacement component at 5:00 PM. The method (800) selects the technician based on the availability of the technician, location of the technician, and job experience of the technician.

The method (800) indicates the type of tools the technician will need to install the replacement component as well as any other instructions for installing the replacement component. This helps minimize the time needed to install the replacement component.

Such a method (800) allows the fabrication of the replacement component to be fabricated onsite if the selected additive manufacturing device is located in the same location as the device.

What is claimed is:

1. A system comprising:
an interface to receive data from a number of sensors coupled to components of a device to monitor health of each of those components; and
a processor and memory to, in response to a determination that a first of the components is to be replaced, locate an additive manufacturing device that is capable of fabrication of a replacement component without interrupting fabrication cycles of that additive manufacturing device before the first component fails and to instruct fabrication of the replacement component.

2. The system of claim 1, wherein the processor and the memory locates the additive manufacturing device that is capable of the fabrication of the replacement component without interrupting the fabrication cycles of the additive manufacturing device before the first component fails by:
determining a geographical location of the first component;
based on the geographical location of the first component, determining additive manufacturing devices capable of fabricating the replacement component without reducing quality of the replacement component;
determining, based on a pareto-optimization, available time slots of the additive manufacturing devices for the fabrication of the replacement component; and
select the additive manufacturing device to fabricate the replacement component during one of the available time slots.

3. The system of claim 1, further comprising a database to store a number of digital files, the digital file corresponding to machine-readable instructions for the fabrication of the replacement component.

4. The system of claim 1, wherein a physical location of the additive manufacturing device to the device is a local location or a remote location.

5. The system of claim 1, wherein a Kalman filter is used to merge the data of the sensors to determine the health of the components of the device.

6. The system of claim 1, wherein the processor and the memory further schedules a service appointment with a technician to install the replacement component in the device based on a completion time of the fabrication of the replacement component.

7. The system of claim 1, wherein the processor and the memory further determine if a service level agreement (SLA) is violated before the fabrication of the replacement component.

8. The system of claim 1, wherein the interface further receives the data from production event logs, metrological data, firmware error codes, historical data, service records associated with the device, or combinations thereof.

9. An additive manufacturing device comprising:
an interface to receive data from a number of sensors coupled to components of the additive manufacturing device to monitor health of each of those components; and
a processor and memory to, in response to a determination that a first of the components is to be replaced, determine an available time slot for the additive manufacturing device to fabricate a replacement component such that fabrication of the replacement component does not interrupt fabrication cycles of the additive manufacturing device before the first component fails and to instruct fabrication of the replacement component.

10. The additive manufacturing device of claim 9, wherein the interface further receives the data from historical data and service records associated with the additive manufacturing device to further determine the health of each of those components such that the determination that the first of the components is to be replaced is based on a time.

11. The additive manufacturing device of claim 9, wherein the available time slot for the additive manufacturing device is determined by:
determining all available time slots for the additive manufacturing device;
determining a duration of each of the available time slots;
determining a length of time for the fabrication of the replacement component; and
based on a comparison of the duration of each of the available time slots and the length of time for the fabrication of the replacement component, select the available time slot.

12. A method for fabricating a replacement component comprising:
with an interface, receiving data from a number of sensors coupled to components of a device to monitor health of each of those components; and
with a processor and memory, in response to a determination that a first of the components is to be replaced, locating an additive manufacturing device that is capable of fabrication of a replacement component without interrupting fabrication cycles of that additive manufacturing device before the first component fails and to instruct fabrication of the replacement component.

13. The method of claim 12, further comprising accessing a database to retrieve a digital file for the fabrication of the replacement component.

14. The method of claim 12, further comprising scheduling a service appointment with a technician to install the replacement component in the device based on a completion time of the fabrication of the replacement component.

15. The method of claim 13, wherein a physical location of the additive manufacturing device to the device is a local location or a remote location.
